(19) United States
(12) Patent Application Publication
(10) Pub. No.: US 2006/0117570 A1
(43) Pub. Date: Jun. 8, 2006

(54) Utility Knife with Cam Clamp Means

(76) Inventor: Dan B. Pool, Scottsdale, AZ (US)

Correspondence Address: Designer Products, 8180 N. Hayden Rd. Suite D-203, Scottsdale, AZ, 85281, US

(21) Appl. No.: 10/904,962

(22) Filed: Dec. 7, 2004

(51) Int. Cl. B26B 1/08

(52) U.S. Cl. 30/162; 30/329

(57) ABSTRACT

A Utility Knife including a cam clamping lever with opposed forward interlocking lobes that allows the two halves of the utility knife to swivel in a scissor-like motion in one direction for blade change and retrieval. The two halves are held together by the cam clamp tension pin and the cam clamp lever. The rotating motion of the cam clamp lever and tension pins relieve pressure from the two halves of the knife and blade thus allowing sufficient opening clearance for blade change.

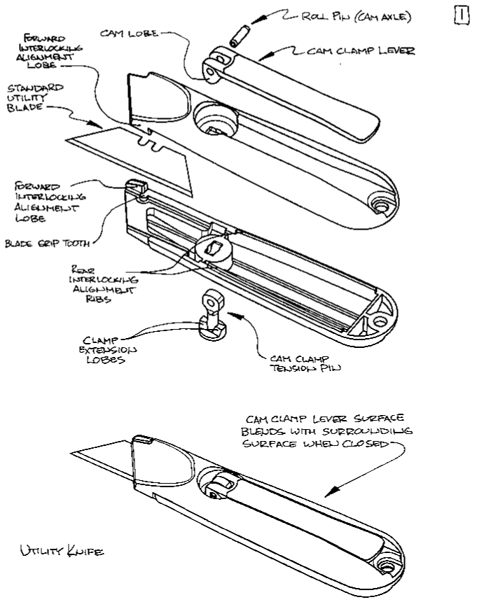

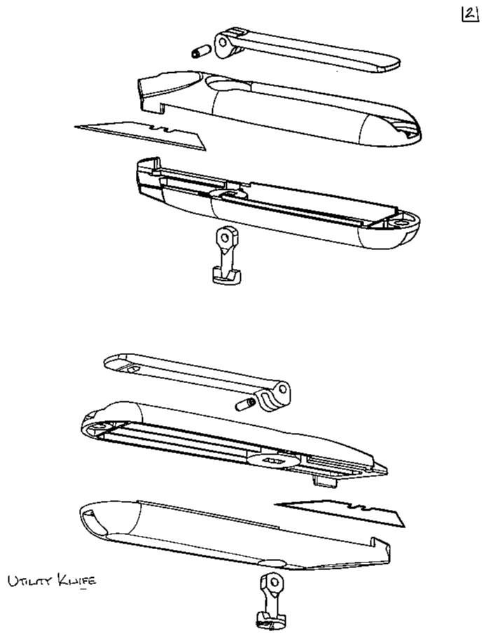

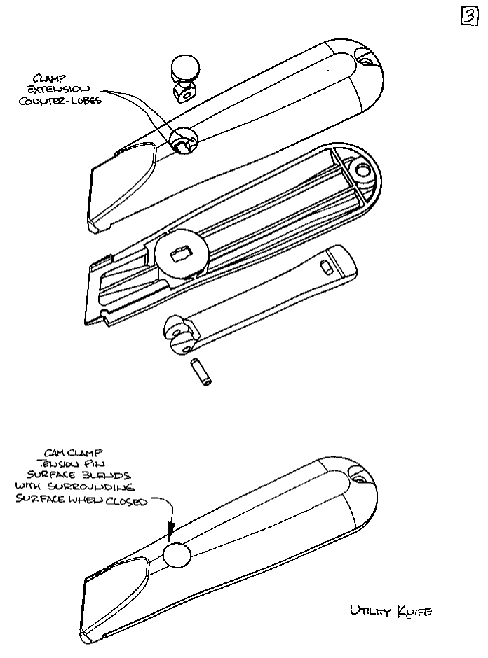

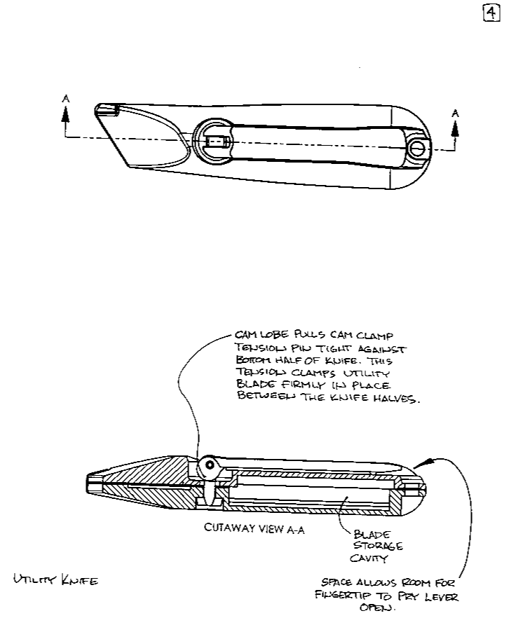

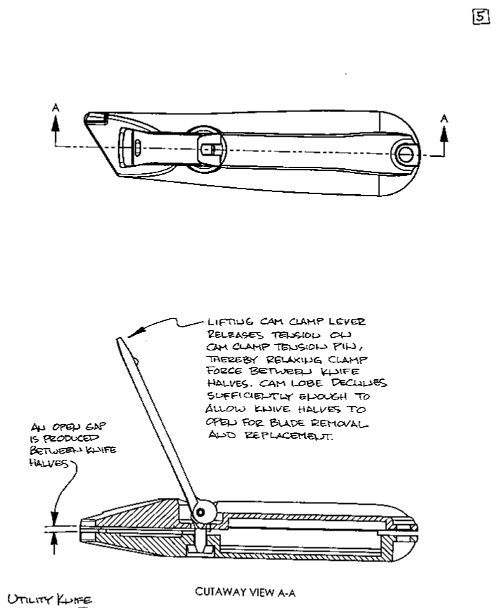

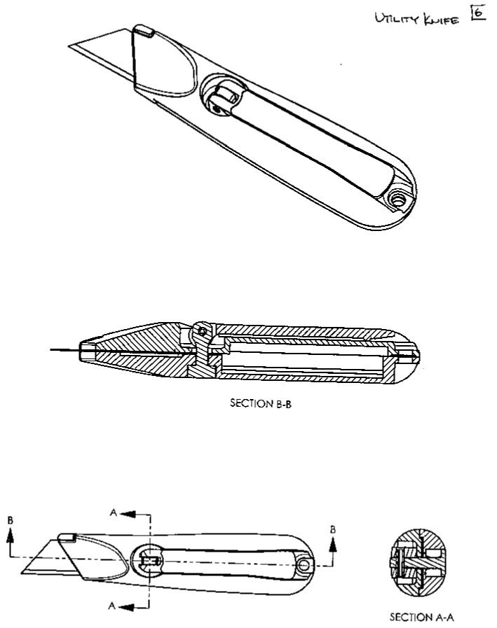

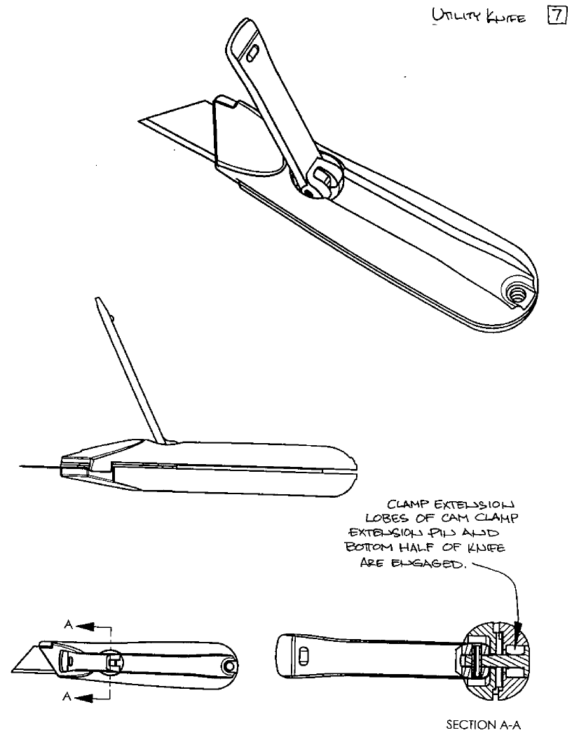

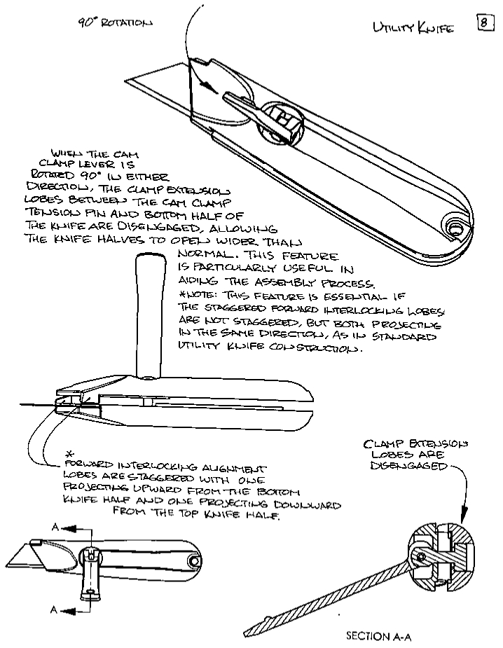

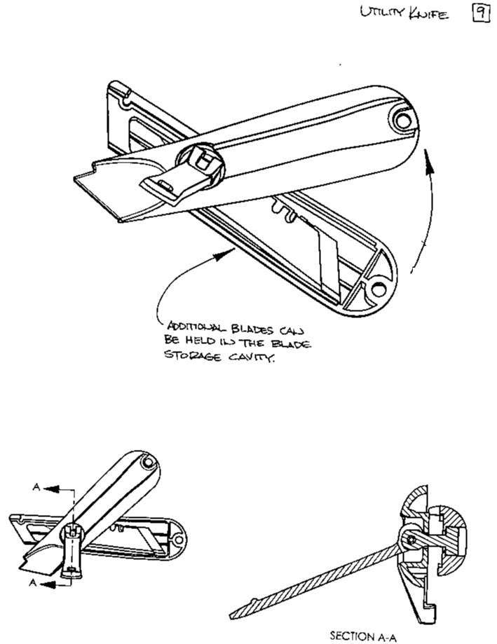

Ordinary utility knife design requires a fastener of some sort to hold the halves of the knife together. This fastener is typically a threaded screw, requiring a screwdriver or similar tool to simply replace the blade. My invention overcomes this limitation present in ordinary utility knife designs by allowing blades to be replaced with the movement of a lever. The lever has a cam lobe and pivot at its end, allowing force to be applied to the two halves of the knife and the blade without the need for a threaded fastener.

Utility knife with cam clamping means includes an upper housing and an interlocking lower housing coupled with a cam clamp lever mechanism. The cam clamping mechanism includes a clamping surface extending from the lower housing to join the rotating halves. The cam clamp lever surface blends with the surrounding upper surface when closed. When the lever is lifted out of its recessed pocket in the knife handle, the cam rotates and relieves pressure from the two halves of the knife and blade, allowing the two halves of the knife to open for blade change or retrieval. The attached drawings show how this is accomplished with two possible means.

What is claimed is:

1. A utility knife comprising a cam clamping means with opposed forward interlocking lobes—each half of the knife has its own interlocking lobe. In this case, the knife halves could swivel in scissor-like motion in one direction and would need to be open only enough to clear the rear interlocking alignment ribs.

2. A Utility knife with cam clamping means as claimed in claim 1; with both forward interlocking lobes on the same knife half. In this case, the knife halves could swivel in either direction, but would need to open sufficiently to clear the forward interlocking lobes and would therefore require the additional clearance available from the clamp extension lobes on the cam clamp tension pin by rotating the lever 90 degrees in either direction.

3. A Utility knife with cam clamping means as claimed in claim 1; A variety of knife handle styles can be used with this same clamping means so the utility of this idea can be expanded to all sorts of existing utility knife designs.

4. A Utility knife with cam clamping means as claimed in claim 1; This idea could also be applied to retractable-blade utility knife designs by clamping only the two halves of the knife together without clamping the blade itself—allowing the blade to be retracted without interference from the knife halves.
